(19) United States
(12) Patent Application Publication
(10) Pub. No.: US 2011/0029750 A1
(43) Pub. Date: Feb. 3, 2011

(54) METHOD AND APPARATUS FOR MANAGING DATA USING JAVA APPLICATION IN MOBILE TERMINAL

(75) Inventors: Ji Won Jang, Seoul (KR); Young Hae Kim, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/845,019

(22) Filed: Jul. 28, 2010

(30) Foreign Application Priority Data
Jul. 30, 2009 (KR) 10-2009-0070208

(51) Int. Cl. G06F 12/16; G06F 12/00

(52) U.S. Cl. 711/162; 711/E12.001; 711/E12.103

(57) ABSTRACT

A method and apparatus for managing data acquired by means of a Java application in a mobile device having a backup interface to an external interface. At least one location information acquired by execution of a Java application is stored within an internal memory. A backup request signal for storing in an external memory the location information selected from among the at least one location information contained in an internal memory is detected. The selected location information is backed up to the external memory through a backup interface established between the internal memory and the external memory in response to the backup request signal.

### CLAIM OF PRIORITY

This application claims the benefit of priority under 35 U.S.C. §119(a) of a Korean patent application filed in the Korean Intellectual Property Office on Jul. 30, 2009 and assigned Serial No. 10-2009-0070208, the entire disclosure of which is hereby incorporated by reference.

### BACKGROUND OF THE INVENTION

1. Field of the Invention

The present invention relates to data management in a mobile terminal. More particularly, the present invention relates to a method and apparatus for managing data acquired by means of a Global Positioning System (GPS) Java application in a mobile terminal.

2. Description of the Related Art

A mobile device can be configured to perform a plurality of supplementary functions in addition to a basic voice communication function. Typical mobile terminals in the current market are equipped with the functions such as Short Message Service (SMS), Multimedia Message Service (MMS), wireless Internet access, phonebook, electronic organizer, gaming, and even navigation, just to name a few of such functions. In case of navigation function, the location information is acquired by means of a Global Positioning System (GPS) module so as to provide a road guidance service. The navigation function that can be implemented with a GPS Java application is executed to acquire the location data and provide a user with the road guidance service based on the location data.

However, the data acquired by the GPS Java application can be stored only in the internal memory of a conventional mobile terminal. That is, the conventional mobile terminals do not provide any interface to backup the data stored within the internal memory into an external memory. This lack of backup means that there is no way for a user to share the data acquired by the GPS java application with other users. Also, when the of a mobile terminal equipped with the GPS Java application exchanges his/her current mobile terminal with another one, it is impossible to transfer the data stored in the old mobile terminal to the new one, resulting in inconvenience of the re-entry of data in the new phone.

### SUMMARY OF THE INVENTION

The present invention provides a method and apparatus for managing data unknown heretofore that is provides a backup interface for backing up the data in a mobile terminal obtained by means of a GPS Java application and then preserved in the internal memory of a mobile device to an external memory.

Also, the present invention provides a method and apparatus for managing data that can share the data among the GPS java application-enabled mobile terminals by backing up the data to an external memory.

In accordance with an exemplary aspect of the present invention, a method for storing data of a mobile terminal preferably includes preserving (storing) at least one location information acquired by execution of a Java application within an internal memory of the mobile terminal; detecting a backup request signal for storing in an external memory at least one location information selected from among the at least one location information contained in the internal memory; and backing up the at least one selected location information by storing a copy in the external memory through a backup interface established between the internal memory and the external memory in response to the backup request signal.

In accordance with another exemplary aspect of the present invention, a method for transferring data of a mobile terminal includes detecting by a first mobile terminal a presence of a transfer request signal for transferring location information to a second mobile terminal; determining upon detection of the transfer request signal whether or not the location information is stored in an external memory; selecting, if the location information is stored in the external memory, one of at least one transfer method for transferring the location information; and transferring the location information with the selected transfer method to said second mobile terminal.

In accordance with still another exemplary aspect of the present invention, an apparatus for backup of data acquired by a java application of a mobile terminal includes a storage unit which stores at least one location information acquired by execution of a Global Positioning System (GPS) Java application; an interface unit which provides a connection interface for transferring a at least one location information selected from among the at least one location information to an external memory; and a control unit which controls the interface unit to transfer the selected location information to the external memory.

### BRIEF DESCRIPTION OF THE DRAWINGS

The above and other exemplary aspects, features and advantages of certain exemplary embodiments of the present invention will become more apparent from the following description taken in conjunction with the accompanying drawings, in which:

FIG. 1 is a block diagram illustrating a configuration of a mobile terminal storing location information according to an exemplary embodiment of the present invention;

FIG. 2 is a block diagram illustrating a data transfer path in the mobile terminal of FIG. 1;

FIG. 3 is a flowchart illustrating a location information storage procedure using a Java application for a mobile terminal according to an exemplary embodiment of the present invention;

FIG. 4 is a diagram illustrating an exemplary screen for managing location information with the location information storage method according to an exemplary embodiment of the present invention;

FIG. 5 is a diagram illustrating a data format of the location information for use in the location information storage method according to an exemplary embodiment of the present invention;

FIG. 6 is a flowchart illustrating a location information backup procedure using a Java application for a mobile terminal according to an exemplary embodiment of the present invention; and

FIG. 7 is a flowchart illustrating a location information transfer procedure for a mobile terminal according to an exemplary embodiment of the present invention.

### DETAILED DESCRIPTION

Exemplary embodiments of the present invention are described herein with reference to the accompanying drawings in detail. The same reference numbers are used throughout the drawings to refer to the same or like parts. Detailed descriptions of well-known functions and structures incorporated herein may be omitted to avoid obscuring appreciation of the subject matter of the present invention by a person of ordinary skill in the art.

In an exemplary embodiment of the present invention, the term ‘GPS Java application’ denotes a Java application that can acquire and store location information of a specific location requested by a user. Here, the GPS Java application can include Java Specification Request 75 (JSR 75) as a File Connection Application Programming Interface (API), JSR 179 as the Location API, and a Record Management System (RMS) API as the storage region management interface. Particularly in an exemplary embodiment of the present invention, the JSR 75 can act as an interface for coupling the RMS API to the data region of an external memory for backup of the data stored in an internal memory (e.g. RMS DB). The JSR 75 interface is suited to detect the attachment of an external memory to provide the interface for transferring the data stored in the internal memory of the mobile terminal to an external memory. For this purpose, the JSR 75 interface can execute the function to access the data stored in the internal memory of the mobile terminal and the data region of the external memory. That is, JSR 75 accesses the internal memory region to check the size and format of the data related to the location information stored therein. Next, the JSR 75 checks the available space of the external memory and, when the external memory have the space enough for storing the data, provides the backup interface for the data backup. At this time, the data format can be changed depending on the state of the external memory.

In an exemplary embodiment of the present invention, the term ‘location information’ denotes data regarding a specific area or a landmark acquired by way of the GPS Java application. Here, the landmark can be the information regarding a historic building, relic, attraction, or a symbolic building of a city. The location information can be acquired and stored by the GPS Java application within the internal memory in advance and then backed up to an external memory through a backup interface between the internal memory and the external memory. In other words, the mobile terminal can back up the location information stored in the internal memory to the external memory in the same format and feature. Accordingly, the user can transfer the location information backed up in the external memory to another mobile terminal, which heretofore was not possible with conventional mobile terminals.

Although a description is directed to the data as the location information acquired and stored within the internal memory by means of the GPS Java application, the data of the claimed invention is in no way not limited to the location information but can be various types of data.

Although a detailed description is directed to a mobile terminal for explanatory purposes, the present invention is not limited thereto. The mobile terminal may comprise any device(s) supporting connection/coupling to an external memory and GPS Java application, such as a generic cellular phone, a Personal Digital Assistant (PDA), a smart phone, a Global Standard for Mobile Communication (GSM) terminal, a Wideband Code Division Multiple Access (WCDMA) terminal, High Speed Downlink Packet Access (HSDPA) terminal, Word Interoperability for Microwave Access (WiMax) terminal, Universal Mobile Telecommunication Service (UMTS) terminal, and their equivalents.

A description of the GPS Java application for acquiring and saving location information in a mobile terminal according to an exemplary embodiment of the present invention is made herein below.

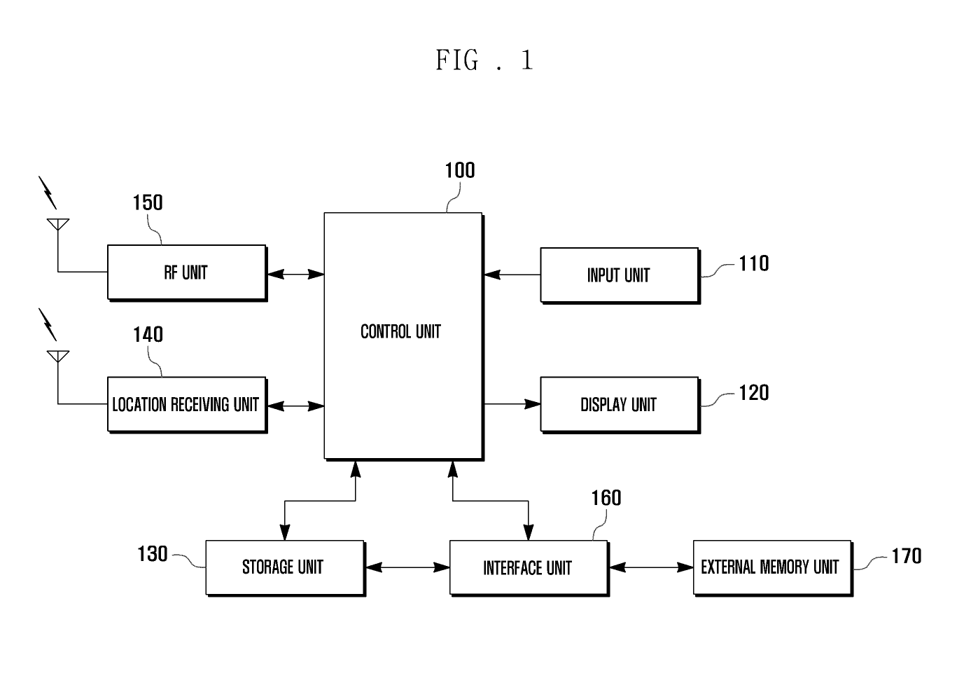

FIG. 1 is a block diagram illustrating an exemplary configuration of a mobile terminal storing location information according to an exemplary embodiment of the present invention.

As shown in FIG. 1, the mobile terminal according to an exemplary embodiment of the present invention preferably includes an input unit 110, a display unit 120, a storage unit 130, a location receiving unit 140, a Radio Frequency (RF) unit 150, an interface unit 160, an external memory unit 170, and a control unit 100. While these items are shown as discrete units for explanatory purposes, a person of ordinary skill in the art understands and appreciates that one or more of these units could be in combination.

The input unit is provided preferably with a plurality of alphanumeric keys for receiving alphabetic and numeric information and function keys for configuring various functions. The function keys can include various navigation keys, side keys, and shortcut keys designated for specific functions. The input unit 110 transfers the key input in association with the user configuration and function control of the mobile terminal to the control unit 100. The input unit 110 can be configured to generate a signal in response to a gesture of the user with at least one of a keypad and a touchpad. The input unit 110 can include be incorporated into the display as a touchscreen or be an additional or auxiliary input implemented on the display unit 120 which can both display and receive information. Particularly in an exemplary embodiment of the present invention, the input unit can include separate or dedicated function keys for executing the GPS Java application, backing up the location information stored inside to an external memory, and for transferring the location information backed up in the external memory to another mobile terminal.

The display unit 120 is responsible for displaying video data output by the control unit 100, user data requested by the user, and other supplementary screens. The display unit 120 can be implemented with, or example a Liquid Crystal Display (LCD). However, the display unit 120 is not limited to the LCD or its equivalents. In an exemplary embodiment of the present invention, the display unit 120 can be implemented with an Organic Light Emitting Diodes (OLED) or any of other application materials for providing a thin-film technology screen. The display unit 120 can be implemented as a touchscreen so as to receive an input in cooperation with the input unit 110, as well as to display execution screens. Particularly in an exemplary embodiment of the present invention, the display unit 120 can be configured to display the screen presenting a map screen in response to the execution of the GPS Java application and the location information requested by the user.

The storage unit 130 typically stores the operating system for booting up the mobile terminal and application programs, e.g. the application for acquiring location information. The storage unit 130 also can store the user data generated while using the mobile terminal. The storage unit 130 can be divided into, for example, a program region and a data region. The program region stores the application programs for supporting the aforementioned functions and loads the application programs in response to the user request. Particularly in an exemplary embodiment of the present invention, the program region stores a program for acquiring location information, a program for providing an interface to back up the location information stored in the internal memory to an external memory, and a program for transferring the location information from the external memory to another mobile terminal.

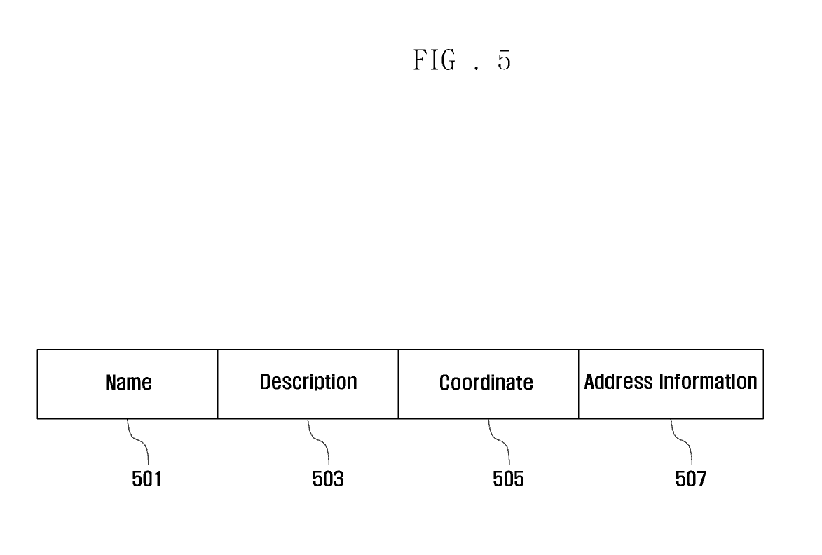

The data region stores the data generated while the application programs are running and input by the user and the location information. Particularly in an exemplary embodiment of the present invention, the data region can store the location information acquired by the GPS Java application. In order to improve the data management efficiency, the location information acquired by the GPS Java application can be stored in the form of a database or table. For example, the location information can be stored in the form of a Record Management System Database (RMS DB). In this case, the location information can include the information fields of Name, Description, Coordinate, Address information, etc. Here, “Name” denotes the name of specific location information, “Description” denotes details of specific location information, “Coordinate” denotes a geographical position of a specific location, and “Address” information denotes an administrative address. A description is made of the location information in detail later with reference to FIG. 5.

With continued reference to FIG. 1, the location receiving unit 140 collects the data on the current location of the mobile terminal in response to a signal from the input unit and transfers the collected data to the control unit 100. The location receiving unit 140 acquires the location information of an area or a landmark according to the execution of the GPS Java application of the mobile terminal. The location receiving unit 140 is optionally configured to be activated automatically upon detection of the execution of the GPS Java application or in response to a specific key input by the user.

The RF unit 150 provides transceiving functions by transmitting/receiving signals associated with the SMS, MMS, voice communication, and other types of data communication services. The RF unit 150 also converts into radio signals the voice/sound data and control data to be transmitted, and also converts the received radio signal into voice/sound data and control data that is output. The RF unit 150 may include an RF transmitter for up-converting and amplifying the transmission signal and an RF receiver for low noise amplifying and down-converting the received signal. In a particularly exemplary embodiment of the present invention, the RF unit 150 can transmit the stored location information to another mobile terminal by way of MMS or a short range wireless communication technology such as Bluetooth and Infrared Data Association (IrDA), under the control of the control unit 100. The RF unit 150 also can transfer the location information backed up in the external memory to another mobile terminal with one of the aforementioned transfer methods under the control of the control unit 100.

The interface unit 160 permits interactions between the external memory to the internal memory of the mobile terminal in response to a user request. That is, the interface unit 160 is provided with an interface for backup of the location information preserved within the internal memory to the external memory. In an exemplary embodiment of the present invention, the interface unit 160 is preferably provided with, for example, a JSR 75 interface that permits backing up the location information stored in the internal memory to the external memory. The JSR 75 interface can access the data storage region of the storage unit 130, e.g. RMS DB, and the data storage region of the external memory. In more detail, the interface unit 160 includes the functions for detecting the attachment of an external memory and for accessing both the data stored in the storage unit 160 and the external memory in order to provide an interface for transferring the location information stored in the storage unit 130 to the external memory. In other words, the interface unit 160 accesses the internal memory region storing the location information to check the size and format of the data and the memory space available in the external memory so, when the external memory has the memory space enough to store the data, as to back up the data to the external memory.

Still referring to FIG. 1, the external memory unit 170 is responsible for coupling the external memory to the mobile terminal so as to copy data from the storage unit 130 to the attached external memory. The external memory unit 170 can be connected to the storage unit 130 through the interface unit 160. The external memory unit 170 executes a backup function for transferring the location information from the storage unit 130 to the external memory via the interface unit 160. For this purpose, the external memory unit 170 is preferably provided with a slot for receiving the external memory. The external memory may comprise, for example, any of a Security Digital (SD) card, Compact Flash (CF) card, Multi Media card, memory stick, just to name a few of the many other types of portable storage media.

The control unit 100 controls entire operations of the mobile terminal and signaling between the internal function blocks of the mobile terminal. In an exemplary embodiment of the present invention, the control unit 100 can control the execution of the GPS Java application. Once the GPS Java application is activated, the control unit 100 causes a standby screen for location information search to be displayed. That is, the control unit 100 controls the display unit 120 to display the data related to the map information as standby screen.

The control unit 100 can preferably control the location receiving unit 140 to acquire the location information in response to a user request. At this time, the control unit 100 commands storage of the acquired location information into the storage unit 130 in the form of the RMS DB. The control unit 100 determines whether or not there is an additional search request for another location, and then acquires the additional location information or terminates the execution of the GPS Java application depending on the determination result.

The control unit 100 can select the specific location information from the storage unit 130 and back up the selected location information to the external memory in response to a backup request signal. The control unit 100 preferably controls such that the interface unit 160 couples the internal memory region and the external memory region. The control unit 100 judges whether an external memory is coupled to the external memory unit 170 upon detecting the backup request signal for backing up the location information to the external memory. In case that no external memory is detected, the control unit 100 can control such that an alarm message requesting, for example insertion, enabling or powering on of an external memory to the external memory unit 170 is displayed. In case that an external memory is detected, the control unit 100 controls display of a location information list such that at least one location information item selected by the user from the location information list is backed up to the external memory through the interface unit 160. The data formats of the location information stored in the mobile terminal and the external memory preferably are identical with each other, and may include, for example, the meta information of Name, Description, Coordinate, Address, etc. The control unit 100 determines whether or not an additional backup request signal is detected, and performs an appropriate operation depending on the determination result.

The control unit 100 can detect a transfer request signal for transferring specific location information to another mobile terminal. At this time, the control unit 100 checks the storage region of the requested location information and, if the requested location information is stored in the external memory unit 170, transfers the location information to another mobile terminal. Meanwhile, if the requested location information is stored in the internal memory, the control unit 100 causes an indication, such as a popup message to be displayed on the screen requesting backup of the location information to the external memory. Afterward, the control unit 100 can transfer the requested location information to another mobile terminal through a location information transfer method selection process or according to a predetermined transfer method. For example, the control unit 100 can control the display unit 120 to display a transfer method selection screen for the user to select one of multiple transfer methods and then control the RF unit 150 to transfer the location information to another mobile terminal with the selected transfer method. The transfer methods can include MMS, Bluetooth, Zigbee, and IrDA.

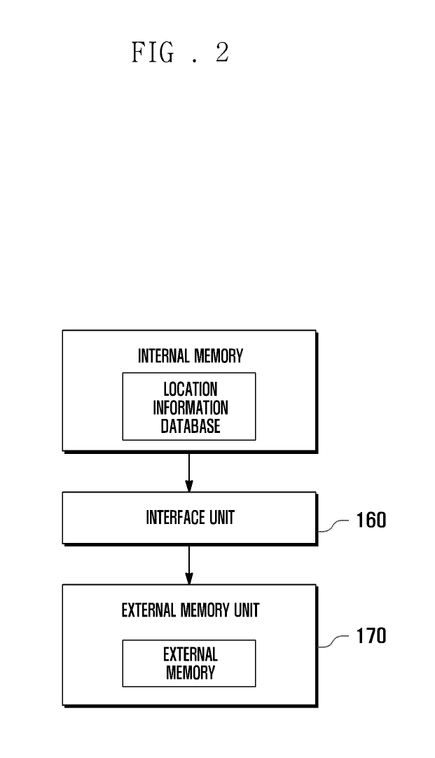

FIG. 2 is a block diagram illustrating a data transfer path in the mobile terminal of FIG. 1.

Referring now to FIG. 2, the mobile terminal can store the location information acquired by way of the GPS Java application in its internal memory. The internal memory can be the storage unit 130 of the mobile terminal 100, or could be a cache storage, for example, that is part of the control unit or in communication with the control unit. The storage unit 130 can preserve the previously acquired location information. The location information can be stored in the form of an RMS DB.

The mobile terminal can back up the location information to the external memory in response to a user request. The mobile terminal can be configured to provide a function for coupling the internal memory and the external memory via the interface unit 160. The interface unit 160 supports the backup of the location information stored in the internal memory to the external memory through, for example, the JSR 75 interface. For this purpose, the interface unit 160 has the function for accessing the internal memory storing the location information and the data storage region of the external memory. That is, the interface unit 160 accesses the internal memory region storing the location information to check the data size and format of the location information and compare the data size with the available space of the external memory so, when the space of the external memory is enough for the location information, as to perform backup of the location information to the external memory.

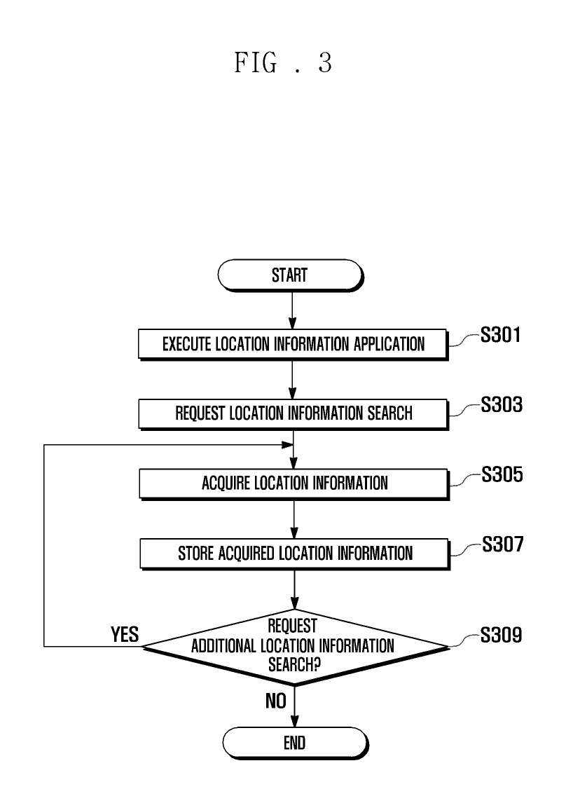

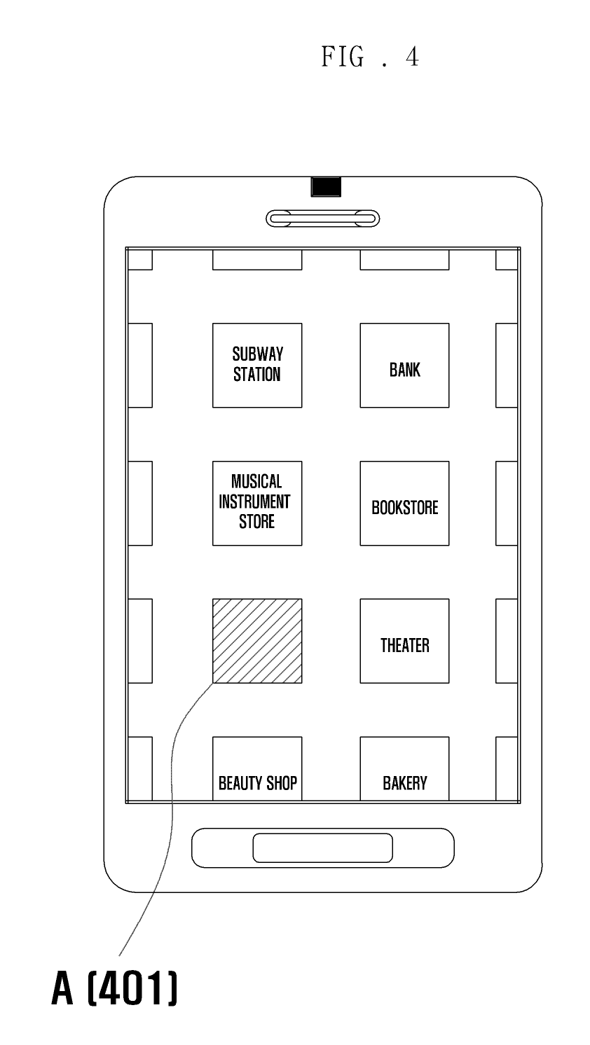

FIG. 3 is a flowchart illustrating a location information storage procedure using a Java application for a mobile terminal according to an exemplary embodiment of the present invention, FIG. 4 is a diagram illustrating an exemplary screen for managing location information with the location information storage method according to an exemplary embodiment of the present invention, and FIG. 5 is a diagram illustrating a data format of the location information for use in the location information storage method according to an exemplary embodiment of the present invention.

Referring now to FIGS. 3 to 5, the mobile terminal according to an exemplary embodiment of the present invention preferably acquires location information with a GPS Java application. At (S301), the control unit 100 of the mobile terminal first executes the GPS java application in response to the request signal input by the user. The request signal can be input, for example, by clicking a function key of the input unit 110 and, if the mobile terminal is implemented with a touchscreen, by touching a specific area of the touchscreen. The control unit 100 can cause the execution screen of the GPS Java application is displayed. That is, the control unit 100 can control to display the execution screen such as map data and GPS java application standby screen.

Once the GPS Java application is executed, at (S303) the control unit 100 can detect a location information search request signal. The location information can be, for example, the data on a specific area or a landmark acquired by the GPS Java application in response to the user request. Next, at (S305) the control unit 100 controls the location receiving unit 140 to acquire the location information of the corresponding location. For example, if the GPS java application is executed, the control unit 100 controls such that, for example, the map information screen of the corresponding area as shown in the example of FIG. 4 is displayed. At this time, the control unit 100 can acquire the data of a specific location (A) 401.

If at (S305) the location information is acquired, then at (S307) the control unit 100 can control such that the acquired location information is stored in the internal memory. The control unit 100 can be configured such that the location information selected in response to the user's selection signal or the location information acquired by means of the GPS Java application is stored in the internal memory automatically. Here, the location information can be formatted as shown in FIG. 5. The location information can be stored within the storage unit 130 in the form of a database with, for example, Name 501, Description 503, Coordinate 505, and Address information 507. Here, Name 501 denotes the official name of a specific landmark, e.g. ‘Seoul Medical’, ‘National Assembly’, and ‘Seoul Grand Park’. Description 503 denotes the category of the corresponding location, e.g. ‘hospital’, ‘conference center’, and ‘zoo’. Coordinate 505 denotes the geographical position coordinate of the specific location, e.g.‘137^{th} degree of east longitude’ and ‘125^{th} degree of west longitude’. Address 507 denotes the administrative address of the specific location, e.g. ‘Yoksam-dong, Gangnam-gu, Seoul’ and ‘Yeouido-dong, Yeongdeungpo-gu, Seoul’, and ‘Gwacheon-si, Gyeonggi-do’.

After storing the location information at (S307), then at (S309) the control unit 100 determines whether a request signal for additional location information search is detected. The control unit 100 can performs the location information search process repeatedly whether the location information request signal is detected. If no request signal is detected, the control unit 100 acquired the location information using the GPS Java application and terminates the exemplary location information storage procedure.

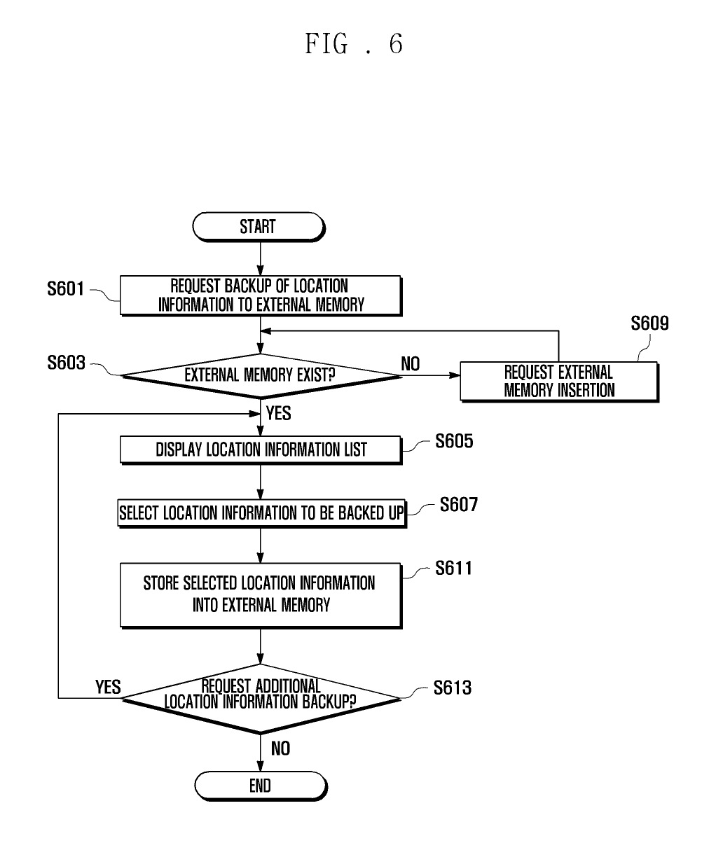

FIG. 6 is a flowchart illustrating a location information backup procedure using a Java application for a mobile terminal according to an exemplary embodiment of the present invention.

Referring now to FIG. 6, the mobile terminal according to an exemplary embodiment of the present invention backs up the location information acquired by way of the GPS java application and stored in its internal memory to an external memory.

At (S601), the control unit 100 detects a request signal for backing up the location information which is stored in the storage unit 130 in the form of an RMS DB in response to a user request to an external memory.

If at (S601) the request signal is detected, then at (S603) the control unit 100 checks the external memory unit 170 to determine whether an external memory is attached. The external memory may comprise any of a variety of types of storage media, including but in no way limited to an SD memory card, CF memory card, Multimedia Memory card, memory stick, and portable disc storage, just to name a few of the many varied possible types of storage.

If it is determined at (S603) that no attached external memory exists, then at (S609) the control unit 100 alarms to request insertion of an external memory. That is, the control unit 100 controls the display unit 120 to display and/or sound an alarm message (preferably in the form of a popup window) requesting insertion/enabling of an external memory. Otherwise, if it is determined at (S603) that an external memory exists, then at (S605) the control unit 100 controls such that a location information list. That is, the control unit 100 searches the storage unit 130 for the location information acquired by the GPS java application and displays retrieved location information items on the display unit 120 in the form of a location information list.

While the location information list is displayed on the screen, at (S607) the control unit 100 detects a user input signal for selecting location information from the location information list. At this time, at least one location information item can be selected from the location information list according to the user input signal.

Once the location information selection at (S607) has completed, then at (S611) the control unit 100 stores the selected location information (items) into the external memory. The control unit 100 can control the interface unit 160 to back up the location information by retrieving the information stored in the storage unit 130 and saving it in the external memory. The backup is preferably merely a copy of the data, but it is possible that the information is extracted and becomes available for additional information once the backup is successful. At this time, the location information is stored preferably in the same data format as that stored within the internal memory. Here, the interface unit 160 can be, for example, the exemplary JSR 75 interface such that the location information stored in the internal memory is backed up to the external memory through the JSR 75 interface. For this purpose, the JSR 75 interface can execute the function for accessing the storage unit 130 containing the location information and the data storage region of the external memory. At this time, the exemplary JSR 75 interface accesses the internal memory region storing the location information to check the data size and format of the location information and compares the data size with the memory space available in the external memory such that, when the memory space of the external memory is enough for storing the location memory, provides the backup interface.

After the selected location information is stored in the external memory, at (S613) the control unit 100 determines whether an additional backup request signal for backing up other location information is detected. If an additional backup request signal is detected, the procedure goes back to (S605) and thus the control unit 100 displays the location information list on the screen such that the user can select another location information item from the location information list. Otherwise, if no additional backup request signal is detected, the control unit 100 terminates the location information backup procedure.

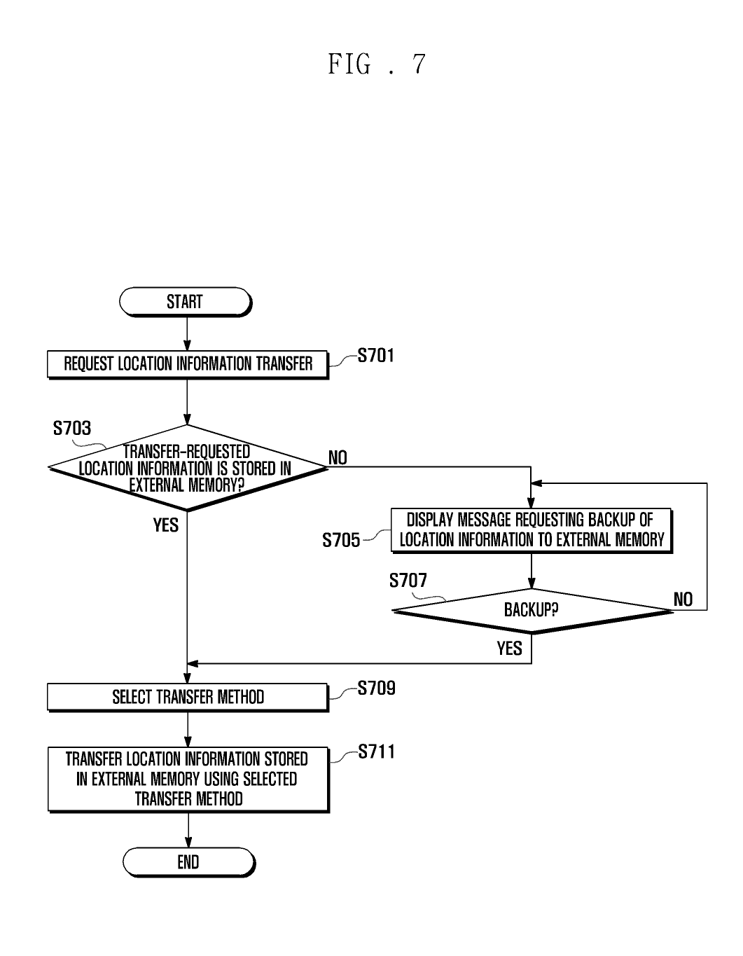

FIG. 7 is a flowchart illustrating a location information transfer procedure for a mobile terminal according to an exemplary embodiment of the present invention.

Referring now to FIG. 7, at (S701) the control unit 100 detects a transfer request signal for transferring the location information. The transfer request signal can be generated by a key input. Before detecting the transfer request signal, the control unit 100 can display the location information list containing the location information items stored in the storage unit 130 and the external memory in order for the user to select the location information to be transferred. The location information can be stored within the external memory in the same data format as in the internal memory. That is, the location information stored in the external memory is stored in the form of a database having the Name field 501, Description field 503, Coordinate field 505, and Address information field 507.

Next, at (S703) the control unit 100 determines whether the location information requested by the transfer request signal exists within the external memory.

If it is determined at (S703) that the transfer-requested location information does not exist in the external memory, then at (S705), the control unit 100 displays a backup request alarm message for backup of the transfer-requested location information in the form of a popup window. After displaying the backup request alarm message, at (S707) the control unit 100 checks periodically whether the transfer-requested location information exists in the external memory. That is, the control unit 100 checks periodically whether or not the transfer-requested location information is backed up within the external message. If it is determined at (S703) that the transfer-requested location information exists in the external memory, then at (S709) the control unit 100 selects a transfer method for transferring the location information. At this time, the control unit 100 can display a transfer method selection screen on the display unit 120 such that the user can select one the transfer methods listed on the transfer method selection screen. If the transfer-requested location information is not backed up at step S707, the control unit 100 can control such that the backup request alarm message is displayed periodically until a termination command is input.

If at (S703) it is determined that the transfer-requested location information exists in the external memory, then at (S709) the control unit 100 selects a transfer method for transferring the location information in response to a user input.

Once a transfer method is selected at step (S709), then at (S711) the control unit 100 transfers the location information to a counterpart mobile terminal using the selected transfer method. For example, the location information can be transferred to the counterpart mobile terminal by means of the MMS service or the short range wireless communication technology such as Bluetooth, IrDA, and Zigbee.

As described above, the data management method and apparatus of the present invention is capable of backing up the location information acquired by the GPS Java application and then stored in the internal memory of a mobile terminal to an external memory through a backup interface, resulting in improvement of data security. Also, the data management method and apparatus of the present invention is capable of sharing the data stored with another GPS Java application-executable mobile terminal by means of an external memory.

The above-described methods according to the present invention can be realized in hardware or as software or computer code that can be stored in a machine readable recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A method for storing data of a mobile terminal, comprising:
storing at least one location information acquired by execution of a Java application within an internal memory of the mobile terminal;
detecting a backup request signal for storing in an external memory at least one location information selected from among the at least one location information contained in the internal memory; and
backing up the at least one selected location information by storing a copy in the external memory through a backup interface established between the internal memory and the external memory in response to the backup request signal.

2. The method of claim 1, wherein the Java application comprises a Global Positioning System (GPS) Java application for acquiring location information.

3. The method of claim 1, wherein the at least one location information comprises a name, a description, a coordinate, and an address and is stored at least in one of the internal memory and the external memory.

4. The method of claim 1, wherein backing up the selected location information comprises:
analyzing a size and format of the selected at least one location information by utilizing a Java Specification Request (JSR) 75 interface; and
comparing the size of the selected at least one location information and a capacity available for storage in the external memory.

5. The method of claim 1, wherein backing up the selected location information comprises:
determining whether or not the external memory is coupled to the mobile terminal;
displaying, if the external memory is coupled to the mobile terminal, a list of the at least one location information saved in the internal memory; and
storing the at least one location information selected from the list into the external memory.

6. The method of claim 5, wherein the external memory is coupled to another mobile terminal.

7. The method of claim 5, wherein backing up the at least one selected location information further comprises displaying, if no external memory is coupled to the mobile terminal, a request to connect an external memory to the backup interface of the mobile terminal.

8. The method of claim 5, wherein backing up the selected location information further comprises determining, after storing the selected location information in the external memory, whether or not an additional location information backup request signal is detected.

9. A method for transferring data of a mobile terminal, comprising:
detecting by a first mobile terminal a presence of a transfer request signal for transferring location information to a second mobile terminal;
determining upon detection of the transfer request signal whether or not the location information is stored in an external memory;
selecting, if the location information is stored in the external memory, one of at least one transfer method for transferring the location information; and
transferring the location information with the selected transfer method to said second mobile terminal.

10. The method of claim 9, further comprising requesting, if the location information is not stored in the external memory of the first mobile terminal, a backup of the location information from an internal memory to the external memory of the first mobile terminal.

11. An apparatus for backup of data acquired by a Java application of a mobile terminal, comprising:
a storage unit for storing at least one location information acquired by execution of a Global Positioning System (GPS) Java application;
an interface unit for providing a connection interface for transferring at least one location information selected from among the at least one location information to an external memory; and
a control unit for controlling the interface unit to transfer the selected location information to the external memory.

12. The apparatus of claim 11, wherein the control unit determines, when a backup request signal is detected, whether or not the external memory is coupled to the mobile terminal and, if the external memory is coupled to the mobile terminal, displays a list of the at least one location information stored in the storage unit.

13. The apparatus of claim 12, wherein the control unit displays, when the external memory is not coupled thereto, a message requesting coupling of the external memory to the apparatus by way of the backup interface of the mobile terminal.

14. The apparatus of claim 11, wherein the control unit determines after storing the at least one selected location information into the external memory whether or not an additional location information backup request signal for storing another location information to the external memory is detected.

15. The apparatus of claim 11, wherein when a transfer request signal for transferring a particular location information to another mobile terminal is detected, the control unit determines whether or not the particular location information is stored in the external memory and displays a backup request alarm message for requesting the backup of the particular location information to the external memory, when the location information is not stored in the external memory.

16. The apparatus of claim 15, wherein when the particular location information is stored in the external memory or the backup of the particular location information completes, the control unit displays a transfer method selection screen and transfers the particular location information with a transfer method selected on the transfer method selection screen.

17. The apparatus of claim 11, wherein the interface unit comprises a Java Specification Request (JSR) 75 interface that analyzes a size and format of the at least one selected location information and compares the size of the at least one selected location information with an available storage capacity of the external memory.
